(19) United States
(12) Patent Application Publication
(10) Pub. No.: US 2026/0219845 A1
(43) Pub. Date: Jul. 30, 2026

(54) INFORMATION PROCESSING DEVICE, PROGRAM OUTPUT METHOD, AND PROGRAM RECORDING MEDIUM

(71) Applicant: Panasonic Intellectual Property Management Co., Ltd., Osaka (JP)

(72) Inventors: Tomoyuki KAGAYA, Kanagawa (JP); Yuxuan LOU, Singapore (SG); Jing Yuan THONG, Singapore (SG); Lakshmi SUBRAMANIAN, Singapore (SG); Jayashree KARLEKAR, Singapore (SG); Sugiri Pranata LIM, Singapore (SG); Natsuki MURAKAMI, Kanagawa (JP); Akira KINOSE, Kanagawa (JP); Koki OGURI, Tokyo (JP); Felix Christopher WICK, Hessen (DE)

(73) Assignee: Panasonic Intellectual Property Management Co., Ltd., Osaka (JP)

(21) Appl. No.: 19/455,315

(22) Filed: Jan. 21, 2026

(30) Foreign Application Priority Data
Jan. 29, 2025 (JP) 2025-013021

(51) Int. Cl. G06F 8/33; B25J 9/16

(52) U.S. Cl. CPC G06F 8/33; B25J 9/1664

(57) ABSTRACT

An information processing device includes an input unit that receives an input of a prompt including a query for causing a robot to execute a task and a query example, an acquisition unit that acquires, from a storage that stores a program code used to solve a query for the robot, a program code used to solve a query similar to the query example included in the prompt, and an output unit that causes a large language model that has learned the program code that has been acquired to generate and output a program code that solves the query included in the prompt.

### BACKGROUND

### 1. Technical Field

The present disclosure relates to an information processing device, a program output method, and a program.

### 2. Description of the Related Art

In recent years, a large language model (LLM) shows high inference capability, and application as an agent in various decision-making processes has attracted attention. One promising application of a LLM agent is robot operation. Recent work has shown that LLM can generate text planning and program codes such as Python code for robot operation, which can provide great flexibility and interaction capabilities to robot operation.

When a code to be used for robot operation is generated with a code generator using LLM, a query in which an instruction sentence for the robot is described in a natural language is input as a prompt. Here, LLM can also generate codes when only the query is given as a prompt. However, the code generated in this case has contents obtained by inferring means for solving the query based on general information. Thus, a code suitable for robot operation is not always generated. Then, it is known that the accuracy of an LLM answer can be improved by providing an example answer (example question) as a prompt together with a query to LLM. The technique of enhancing the accuracy of an answer by giving an example answer to LLM to perform simple learning like this may be referred to as In-Context Learning or Few-shot Learning. Here, the example answer includes one or more query examples and program code examples that solve the query examples. The code generator learns the example answer input to the prompt and generates a program code to solve (or achieve or process) the query input to the prompt. The generated program code may be executed by the robot, and the robot may solve the query input to the prompt.

### Citation List

### Patent Literature

PTL 1: Unexamined Japanese Patent Publication No. 2024-043563

### SUMMARY

When an example answer is provided as a prompt together with a query, the program code generated by LLM is not appropriate in some cases when the example answer has an inappropriate or insufficient content. Here, the inappropriate example answer is, for example, an example answer for a robot having a physical structure completely different from the robot to be operated. In addition, the insufficient example answer is, for example, an example answer in which processing such as initialization necessary for normally operating the robot to be operated is missing. In either case, the query cannot be appropriately solved with the program code generated by the code generator in some cases. Thus, when the robot cannot appropriately solve the query based on the program code generated by the code generator, the user adjusts or corrects the example answer and gives it as a prompt again. Adjusting or modifying the example answer may require experience of the user, and the code generator cannot generate an appropriate program code to solve the query in some cases.

Non-limiting examples of the present disclosure contribute to providing an information processing device, a program output method, and a program capable of outputting an appropriate program code without depending on experience of the user.

An information processing device according to one example of the present disclosure includes an input unit that receives an input of a prompt including a query for causing a robot to execute a task and a query example, an acquisition unit that acquires, from a storage that stores a program code used to solve a query for the robot, a program code used to solve a query similar to the query example included in the prompt, and an output unit that causes a large language model that has learned the program code that has been acquired to generate and output a program code that solves the query included in the prompt.

A program output method according to one example of the present disclosure includes accepting an input of a prompt including a query for causing a robot to execute a task and a query example, acquiring, from a storage that stores a program code used to solve a query for the robot, a program code used to solve a query similar to the query example included in the prompt, and causing a large language model that has learned the program code that has been acquired to generate and output a program code that solves the query included in the prompt.

A program according to one example of the present disclosure causes a processor to execute processing of accepting an input of a prompt including a query for causing a robot to execute a task and a query example, acquiring, from a storage that stores a program code used to solve a query for the robot, a program code used to solve a query similar to the query example included in the prompt, and causing a large language model that has learned the program code that has been acquired to generate and output a program code that solves the query included in the prompt.

These comprehensive or specific aspects may be realized by a system, a device, a method, an integrated circuit, a computer program, or a recording medium, or may be realized in any combination of the system, the device, the method, the integrated circuit, the computer program, and the recording medium.

According to one example of the present disclosure, it is possible to output an appropriate program code without depending on experience of the user.

Further advantages and effects in one example of the present disclosure will be clarified from the specification and the drawings. Although such advantages and/or effects are provided by several exemplary embodiments and features described in the specification and drawings, all of them are not necessarily provided to obtain one or more identical features.

### BRIEF DESCRIPTION OF THE DRAWINGS

FIG. 1 is a diagram for describing Cross-Environment Knowledge Transfer in a human;

FIG. 2 is a diagram for describing Cross-Environment Knowledge Transfer in EnvBridge;

FIG. 3 is a functional block diagram of an information processing device;

FIG. 4 is a diagram for describing a prompt;

FIG. 5 is a diagram illustrating a program code example generated by a code output unit;

FIG. 6 is a diagram illustrating a program code example of a successful experience stored in a storage;

FIG. 7 is a diagram for describing transfer of a successful experience; and

FIG. 8 is a diagram for describing re-planning.

### DETAILED DESCRIPTIONS

Hereinafter, an exemplary embodiment of the present disclosure will be described in detail with reference to the drawings as appropriate. Unnecessary details may be omitted. For example, detailed descriptions of already well-known matters and redundant descriptions of substantially the same configuration may be omitted. This is to avoid an unnecessarily redundant description below and to facilitate understanding of those skilled in the art.

The accompanying drawings and the descriptions below are provided to enable those skilled in the art to fully understand the present disclosure, and are not intended to limit subject matters described in the scope of claims.

### Overview

In the present disclosure, a new LLM agent (hereinafter, may be referred to as EnvBridge) in robot code generation is provided. EnvBridge leverages knowledge of codes (program codes or programs) generated in environments executed in the past to increase the adaptability of the robot to a new (or another) environment.

EnvBridge uses a process called Cross-Environment Knowledge Transfer to improve the ability of an LLM agent to adapt to different environments. This is inspired by human intelligence, applying successful cases in one benchmark environment to other environments to improve adaptive power and performance so that successful experiences (successful outcomes) in familiar environments are applied to similar tasks in new scenarios.

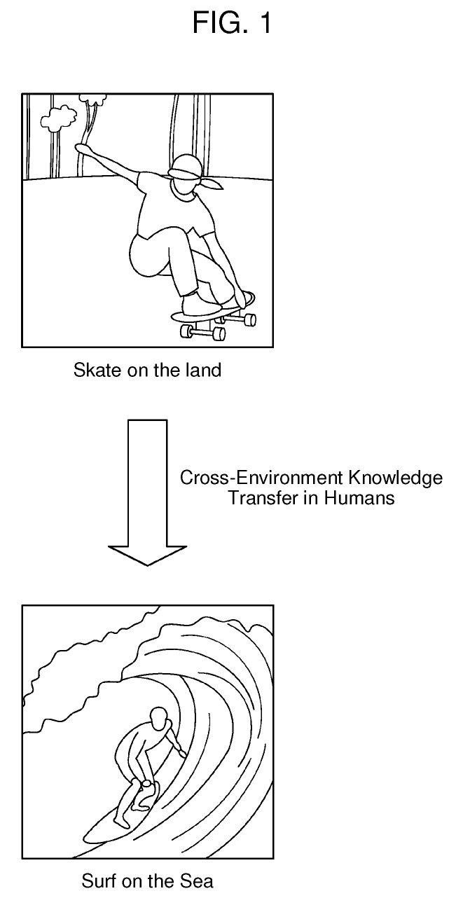

FIG. 1 is a diagram for describing Cross-Environment Knowledge Transfer in a human. For example, when a person experienced in skateboarding performs surfing for the first time, the successful experience in skateboarding is transferred (applied) to surfing. For example, the person experienced in skateboarding applies the position and movement of a limb of the person with respect to a skateboard, weight movement, and the like to surfing.

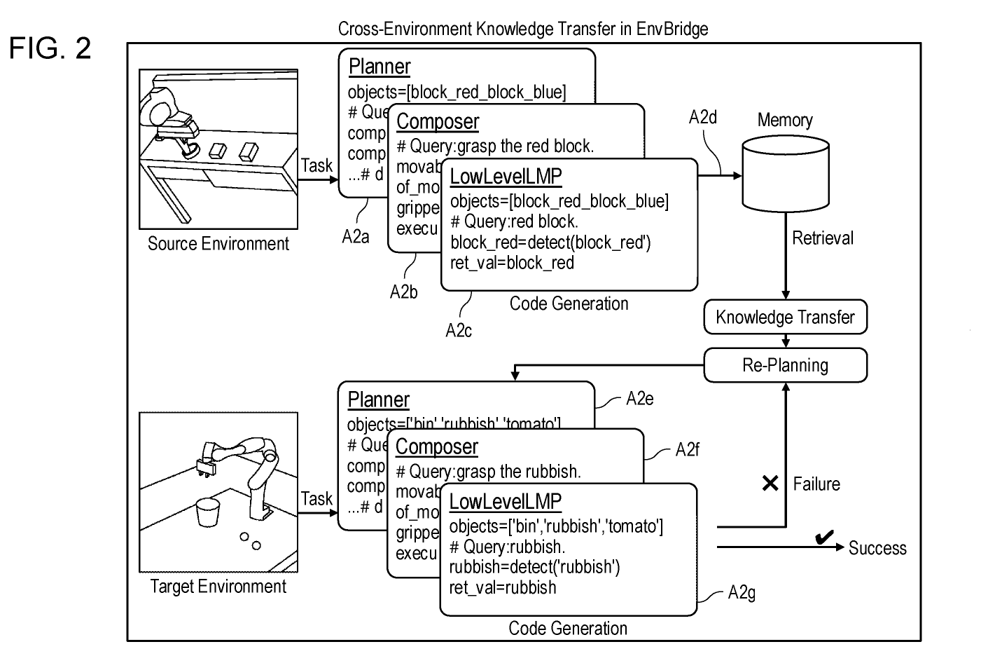

FIG. 2 is a diagram for describing Cross-Environment Knowledge Transfer in EnvBridge. The source environment of FIG. 2 represents a past environment EnvBridge has experienced and may correspond to, for example, the skateboarding in FIG. 1. The target environment in FIG. 2 represents an environment that EnvBridge newly experiences, and may correspond to the surfing in FIG. 1.

EnvBridge includes retention of a successful experience in the source environment to memory and transfer (application) of the successful experience to a new target environment. The successful experience includes, for example, a query for the robot and a program code with which the query is appropriately solved. EnvBridge takes from the memory the past successful experience in the source environment and uses it to generate a program code in the new target environment.

With this configuration, EnvBridge can flexibly deal with new environments and tasks in program code generation of the robot. In addition, EnvBridge can appropriately generate a program code for the robot without depending on pre-training or artificial prompt adjustment.

Hereinafter, a case where EnvBridge is applied to a robot operation benchmark (virtual robot operation environment) will be described. In the present disclosure, for example, a virtual robot operation environment such as Composing Actions from Language and Vision (CALVIN) is set as a source environment, and a virtual robot operation environment different from CALVIN such as Robot Learning Benchmark (RLBench) is set as a new target environment. Alternatively, a virtual robot operation environment such as RLBench is set as a source environment, and a virtual robot operation environment different from RLBench such as CALVIN is set as a new target environment.

Of course, EnvBridge is also applied to a real robot operation environment. For example, EnvBridge may set a real robot operation environment as a source environment and another real robot operation environment as a new target environment (see Modification 1 shown below).

### Block configuration

Hereinafter, an example in which the EnvBridge function is realized in an information processing device such as a personal computer or a server will be described.

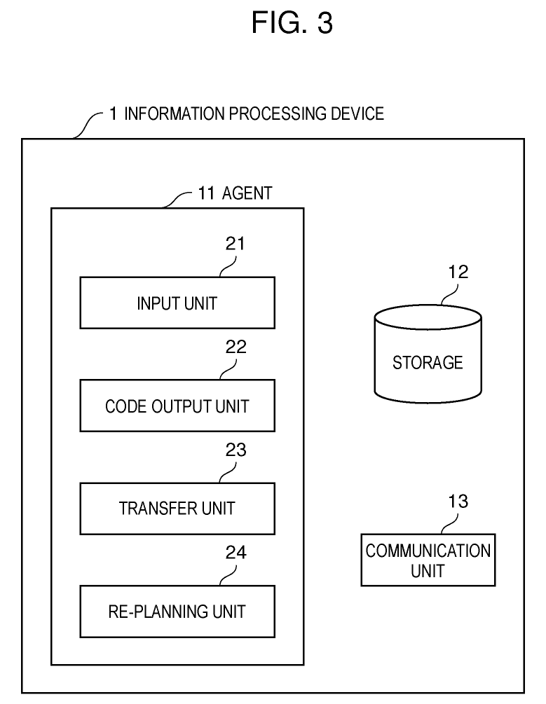

FIG. 3 is a block configuration diagram of information processing device 1. As illustrated in FIG. 3, information processing device 1 includes agent 11, storage 12, and communication unit 13. Agent 11 includes input unit 21, code output unit 22, transfer unit 23, and re-planning unit 24.

Agent 11 is composed of, for example, a processor such as a central processing unit (CPU) or a graphics processing unit (GPU). Agent 11 has the functions of LLM and provides a prompt. Agent 11 may be referred to as LLM agent, LLM, or controller.

### Input unit

Input unit 21 inputs the information input in the prompt. For example, input unit 21 inputs information such as an example answer and a query input to the prompt by a user. The example answer includes one or more query examples in a virtual robot operation environment and one or more program code examples in the virtual robot operation environment that solve the query examples. The query example and the query are instruction sentences for a virtual robot in the virtual robot operation environment, for example, “push the red block left”.

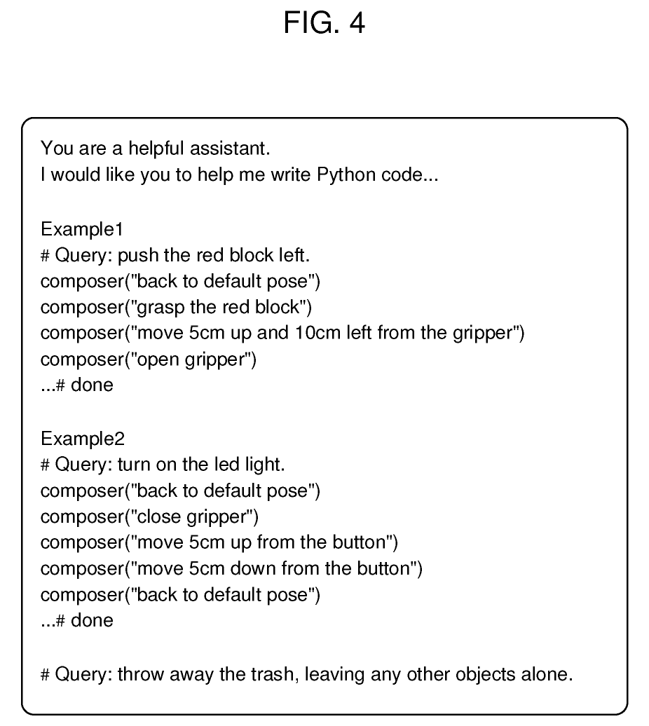

FIG. 4 is a diagram for describing the prompt. In the prompt, for example, an example answer in a virtual robot operation environment such as RLBench is input by the user. In the example of FIG. 4, as shown in “Example1” and “Example2”, two example answers (a query example and a program code example) are input by the user. In addition, in the prompt, a query in a virtual robot operation environment such as RLBench is input by the user. For example, the query shown in the bottom row of FIG. 4 is input to the prompt by the user. Input unit 21 inputs the information input in the prompt.

### Code output unit

Code output unit 22 learns the example answer input to the prompt and generates a program code that solves the query input to the prompt. For example, code output unit 22 learns “Example1” and “Example2” shown in FIG. 4 and generates a program code that solves the query shown in the bottom line of FIG. 4. In other words, code output unit 22 generates a program code according to an example question by being given the example question. Code output unit 22 may generate a program code that solves the query using a technology called In-Context Learning or Few-shot Learning. Code output unit 22 may generate a program code that solves the query using an existing code generator such as VoxPoser. The generation may be regarded as an output. Hereinafter, an example of a case where the program code is generated using VoxPoser will be described.

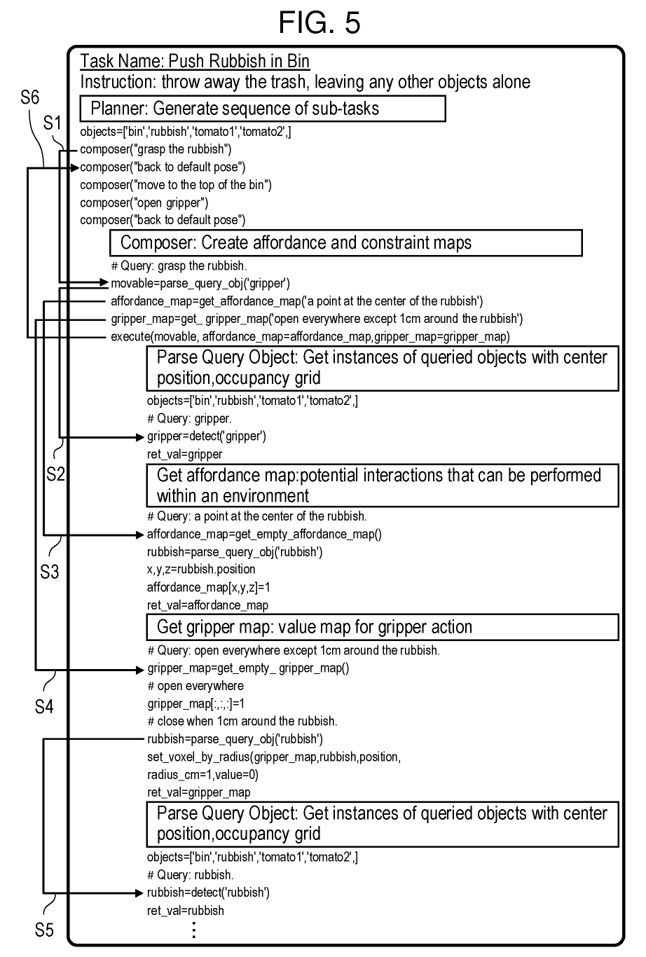

FIG. 5 is a diagram illustrating a program code example generated by code output unit 22. As described above, code output unit 22 learns the example answer input to the prompt and generates a program code for solving the query input to the prompt. To facilitate the role and management of the program code, code output unit 22 generates a program code having a hierarchical structure (multiple levels) from an upper program element toward a lower program element. For example, as illustrated in FIG. 5, code output unit 22 generates program codes in three levels such as a planner, a composer, and low level motion primitives (LMP).

Code output unit 22 generates a code of a lower level by inputting a code of each level to LLM. More specifically, code output unit 22 sets a task for solving the input query based on learning of the example answer. Code output unit 22 decomposes the set task and generates a planner (program code of the first level). Code output unit 22 generates a composer (program code of the second level) for realizing the generated planner (decomposed task). Code output unit 22 generates LMP (program code of the third level) for realizing the generated composer. In addition, code output unit 22 generates program elements in the same level such as parse_query_object, get_affordance_map, and Get gripper map in the level of LMP.

S1 to S6 in FIG. 5 indicate the execution order of the program. For example, the execution of the program shifts from the planner (first level) to the composer (second level) (S1). Execution of the program in the composer is sequentially shifted from the top to LMP (third level) (S2 to S4). The execution of the program may be shifted in the same level (S5). When the program execution in the composer is completed, the execution of the program returns to the planner (S6) and proceeds to the next task processing.

Code output unit 22 stores a program code of a successful experience among the generated program codes, that is, a program code with which the virtual robot has appropriately solved the query, in storage 12.

Whether the program code is a program code of a successful experience (whether the virtual robot has appropriately solved the query) is evaluated (determined) by, for example, a virtual program operation environment (for example, RLBench or CALVIN). Code output unit 22 stores the program code of the successful experience among the generated program codes in storage 12 based on the evaluation result of the virtual program operation environment.

### Storage

Storage 12 is, for example, a solid state drive (SSD), a random access memory (RAM), a flash memory, a read only memory (ROM), or a hard disk drive (HDD). Storage 12 stores a program code and data for realizing the function of agent 11. A program code of a successful experience is stored in storage 12.

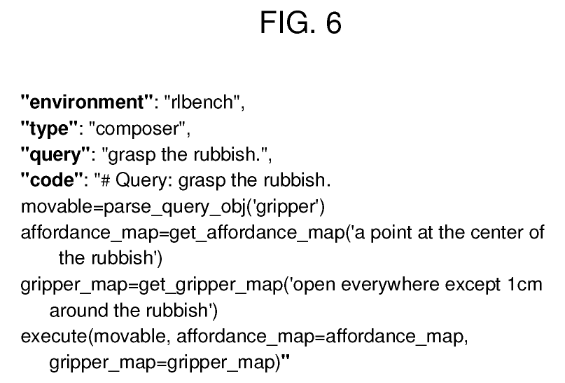

FIG. 6 is a diagram illustrating a program code example of the successful experience stored in storage 12. As illustrated in FIG. 6, storage 12 stores the environment, the type, the query, and the code (program code) in association with each other.

The environment indicates the robot operation environment in which the program code is executed. Examples of the environment include RLBench and CALVIN. The type indicates the level of the program code. The type includes, for example, planner, composer, and LMP. The program code is the program code that has appropriately solved the query.

Storage 12 may store (data of) a query vector obtained through vector conversion of the query (instruction sentence).

The program code stored in storage 12 may be any one of the type of planner, composer, and LMP, or a combination thereof. Storage 12 may be a server or the like provided outside information processing device 1 and shared by a plurality of information processing devices 1 or the like. When the storage is realized as a server or the like, successful experiences in a plurality of environments and information processing devices may be accumulated.

### Transfer unit

Transfer unit 23 accesses storage 12, acquires knowledge (successful experience) in the source environment, and performs processing of transferring the knowledge to the target environment.

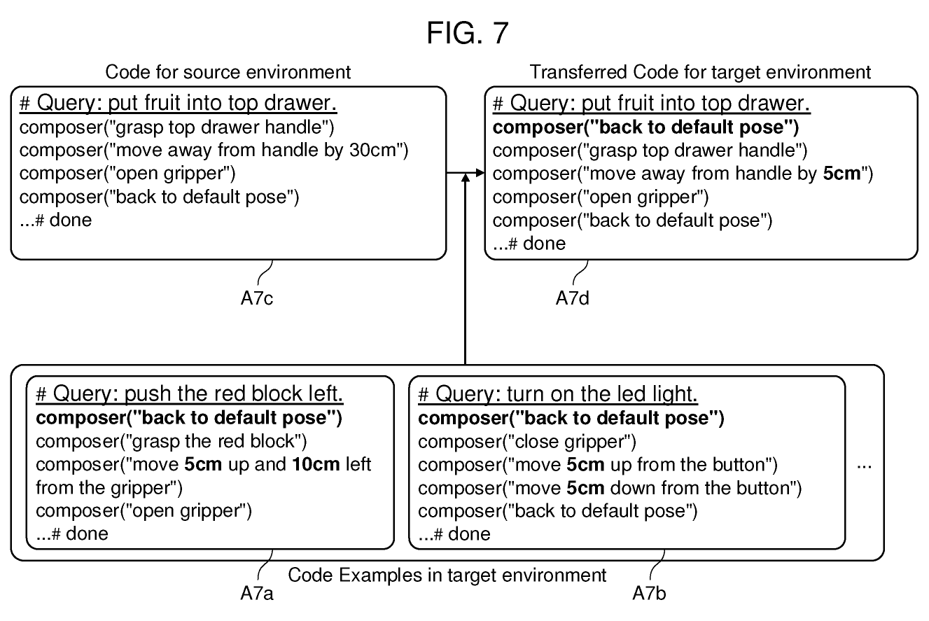

FIG. 7 is a diagram illustrating transfer of a successful experience. Frames A7a, A7b in FIG. 7 illustrate example answers (query examples and program code examples) in the target environment input by the user to the prompt.

Transfer unit 23 acquires a query similar to the query example of the target environment input to the prompt and a program code associated with the query (successful experience) from storage 12 (see frame A7c in FIG. 7). For example, transfer unit 23 performs vector conversion on a query example ("#Query: ..." in frames A7a, A7b in FIG. 7) of the target environment input by the user in the prompt. Transfer unit 23 calculates similarity between the query example of the target environment and the query of the successful experience, by calculating cosine similarity between (data of) the query example vector obtained through vector conversion of the query example and the query vector of the successful experience stored in storage 12. Then, transfer unit 23 acquires, for example, the successful experience having the highest similarity from storage 12. When there are a plurality of example answers in the target environment, vector conversion may be performed on the query example included in each of the example answers, and an average thereof may be used as the query example vector.

The query example used when a successful experience is acquired is not limited to the query example given as the example answer, but may include a query (for example, "Query: throw away the trash, leaving any other objects alone." in FIG. 4) to be solved this time in the target environment. With this configuration, there is a possibility that a more appropriate successful experience can be acquired than the successful experience acquired when only the query example included in the example answer is used, for example, when exactly the same query as the query to be solved this time in the source environment has been solved.

When acquiring the successful experience having the query similar to the query example of the target environment from storage 12, transfer unit 23 converts (edits) the acquired successful experience into a style based on the program code example of the target environment. For example, transfer unit 23 gives an instruction such as “Please complete the Python code to execute the query in the target environment” to the prompt,

and converts the style of the successful experience acquired from storage 12 (see frame A7c in FIG. 7) based on the program code example (see frames A7a, A7b in FIG. 7) of the target environment (see frame A7d in FIG. 7). That is, transfer unit 23 generates an example answer suitable for the target environment based on the successful experience acquired from storage 12 and the example answer in the target environment input by the user to the prompt. In the example of FIG. 7, in the conversion from A7c to A7d, a composer ("back to default pose") is added, and a composer ("move away from handle by 30 cm") is converted into a composer ("move away from handle by 5 cm").

The style conversion is performed by artificial intelligence (LLM). The artificial intelligence that converts the style is given, for example, a successful experience that can be input to storage 12 and a program code example that can be input to a prompt (teaching data) and an example answer (label) to be generated based on the successful experience and the program code example, and a model for generating an example answer suitable for the target environment may be constructed. In the example of FIG. 7, LLM determines, from the contexts of frames A7a, A7b, that a composer ("back to default pose") appears in the first row in the successful experience, and that “5 cm” is often used in the context in which “move” appears, and performs conversion of reflecting these pieces of information in frame A7d.

### Re-planning unit

The program code generated by code output unit 22 is executed in the virtual robot in the target environment. The virtual robot operation environment of the target environment (for example, RLBench or CALVIN) evaluates whether the virtual robot in the environment has appropriately solved the query. When the virtual robot operation environment evaluates that the virtual robot has not appropriately solved the query, re-planning unit 24 generates an example answer suitable for the target environment using transfer unit 23 and inputs the example answer to the prompt. Then, code output unit 22 generates a new program code using the example answer generated by transfer unit 23. That is, when the virtual robot operation environment evaluates that the virtual robot has not appropriately solved the query, re-planning unit 24 re-plans a program code using the example answer generated by transfer unit 23 without depending on artificial prompt adjustment (artificially created example answer).

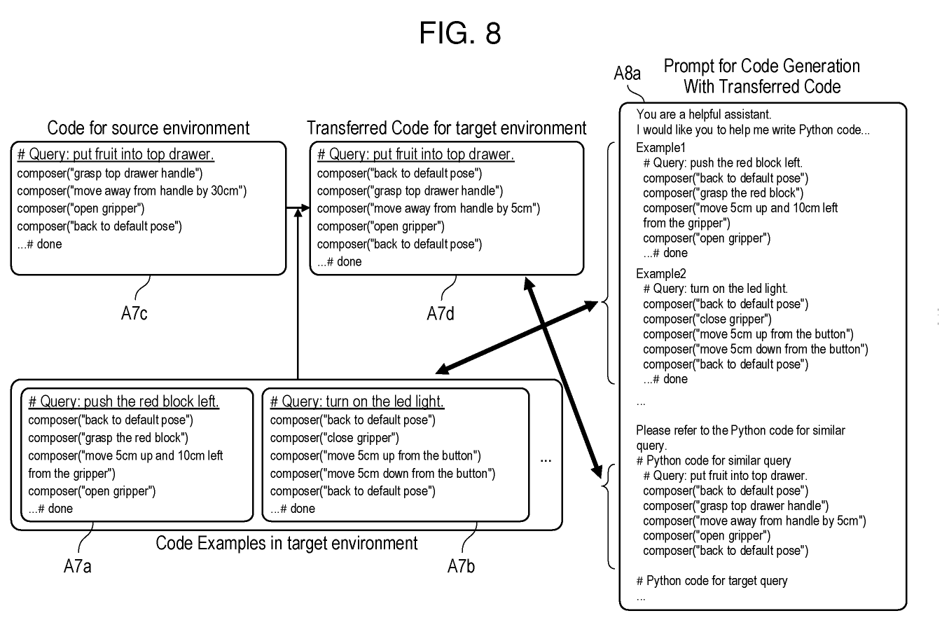

FIG. 8 is a diagram for describing re-planning. In FIG. 8, the same components as those in FIG. 7 are denoted by the same reference numerals. “Example1” shown in prompt A8a in FIG. 8 corresponds to the example answer of frame A7a in FIG. 8. “Example2” shown in prompt A8a in FIG. 8 corresponds to the example answer of frame A7b in FIG. 8. "#Python code for similar query" and subsequent example answers shown in prompt A8a in FIG. 8 correspond to the example answer of frame A7d in FIG. 8.

The user inputs an example answer in the target environment to the prompt (see “Example 1” and “Example2” shown in prompt A8a in FIG. 8). Code output unit 22 learns the example answer input to prompt A8a and generates a program code. The generated program code is executed in the virtual robot in the target environment.

Here, the virtual robot operation environment of the target environment evaluates that the virtual robot has not appropriately solved the query. In this case, re-planning unit 24 generates an example answer (see frame A7d in FIG. 8) suitable for the target environment using transfer unit 23 and inputs the example answer to the prompt (see "#Python code for similar query" and subsequent example answers shown in prompt A8a in FIG. 8).

Transfer unit 23 acquires, from storage 12, a successful experience having a query similar to the query example (see "Example1" and "Example2" in FIG. 8, and frames A7a, A7b) of the target environment input to the prompt as described in “Transfer unit” (see frame A7c in FIG. 8). Transfer unit 23 converts the style of the successful experience acquired from storage 12 based the example answers (see frames A7a, A7b in FIG. 8) of the target environment (see frame A7d in FIG. 8). Re-planning unit 24 inputs the style-converted example answer to the prompt (see "#Python code for similar query" and subsequent example answers in FIG. 8).

The example answer input to the prompt by re-planning unit 24 is learned by code output unit 22, and a program code in the target environment is generated. The generated program code is executed by the virtual robot in the target environment.

### Communication unit

Communication unit 13 communicates with the virtual robot operation environment wirelessly or by wire. For example, communication unit 13 transmits the program code generated by code output unit 22 and the program code re-planned by re-planning unit 24 to the virtual robot operation environment.

### Operation example

The operation of information processing device 1 will be described with reference to FIG. 2. “Memory” illustrated in FIG. 2 may correspond to storage 12 in FIG. 3. "Code Generation" illustrated in FIG. 2 may correspond to the function of code output unit 22 in FIG. 3. “Knowledge Transfer” illustrated in FIG. 2 may correspond to the function of transfer unit 23 in FIG. 3. “Re-Planning” illustrated in FIG. 2 may correspond to the function of re-planning unit 24 in FIG. 3.

The operation of information processing device 1 can be roughly divided into a successful experience storage operation in the source environment and a program code generation operation in the target environment. Hereinafter, the two operations will be described.

The successful experience in the target environment may also be stored in Memory as the successful experience in the source environment. For example, the successful experience obtained in “Target Environment” illustrated in FIG. 2 is also stored in Memory as the successful experience in the source environment.

### Successful experience storage operation

The user inputs an example answer in “Source Environment” illustrated in FIG. 2 and a query desired to be solved by the virtual robot in “Source Environment” in the prompt.

For example, as shown in “Example1” and“ Example2” in FIG. 4, the user inputs an example answer in “Source Environment” to the prompt. As shown in the bottom line of FIG. 4, the user inputs a query desired to be solved by the virtual robot in “Source Environment” to the prompt.

Information processing device 1 learns the example answer input to the prompt and generates a program code that solves the query input to the prompt (see frames A2a, A2b, A2c in FIG. 2). The generated program code is executed in the virtual robot in “Source Environment”. The virtual robot operation environment providing “Source Environment” evaluates whether the virtual robot in the environment has appropriately solved the query. When it is evaluated that the virtual robot has appropriately solved the query, information processing device 1 stores the generated program code in Memory (see an arrow A2d in FIG. 2). That is, information processing device 1 stores the successful experience in “Source Environment” in Memory. As described with reference to FIG. 6, the environment, the type, and the query are also stored in Memory together with the generated program code.

### Program code generation operation in target environment

The user inputs the example answer in “Target Environment” illustrated in FIG. 2 and a query desired to be solved by the virtual robot in“ Target Environment” to solve in the prompt. Similarly to the description of “Successful experience storage operation”, information processing device 1 learns the example answer input to the prompt and generates a program code that solves the query input to the prompt (see frames A2e, A2f, A2g in FIG. 2).

The generated program code is executed in the virtual robot in “Target Environment”. The virtual robot operation environment providing “Target Environment” evaluates whether the virtual robot in the environment has appropriately solved the query. When it is evaluated that the virtual robot has appropriately solved the query (when the virtual robot has successfully solved the query), information processing device 1 ends the program code generation operation in the target environment.

On the other hand, when it is evaluated that the virtual robot has not appropriately solved the query (when the virtual robot has failed to solve the query), information processing device 1 executes re-planning of the program code (see “Re-Planning” in FIG. 2). Information processing device 1 acquires, from Memory, a successful experience similar to the example answer in “Target Environment” input by the user to the prompt and generates an example answer suitable for “Target Environment” based on the example answer in “Target Environment” input by the user to the prompt and the successful experience acquired from Memory (see“ Knowledge Transfer” in FIG. 2). Then, information processing device 1 inputs the generated example answer to the prompt and generates a program code again. The generated program code is executed in the virtual robot in “Target Environment”. Information processing device 1 may repeat the operation of “Re-Planning” and “Knowledge Transfer” until it is evaluated that the virtual robot has appropriately solved the query.

### Summary of exemplary embodiment

As described above, input unit 21 receives an input of a prompt including a query for causing a robot to execute a task and a query example. Transfer unit 23 acquires a program code used for solving a query similar to the query example included in the prompt from storage 12 that stores the program code used for solving the query for the robot. Code output unit 22 causes a large language model that has learned the acquired program code to generate and output a program code that solves the query included in the prompt. This allows information processing device 1 to output an appropriate program code without depending on experience of the user.

### Modification

### Modification 1

As described in <Overview>, information processing device 1 is also applied to a real robot operation environment. In the case of a real robot operation environment, “Source Environment” and “Target Environment” of the virtual robot operation environment illustrated in FIG. 2 are real robot operation environments.

For example, when information processing device 1 is applied to a real robot operation environment, an example answer and a query with respect to a real robot are input to the prompt. Information processing device 1 learns the input example answer and generates a program code for the real robot to solve the query. The generated program code is output (transmitted) to the real robot and executed.

Whether the real robot has appropriately solved the query may be determined by the robot, information processing device 1, or a human. For example, the robot and information processing device 1 may include a plurality of sensors and determine whether the robot has appropriately solved the query based on a signal of the sensor.

When the robot has not appropriately solved the query, information processing device 1 executes re-planning of the program code in the same manner as in the description of the virtual robot operation environment. The re-planned program code is output to the real robot and executed.

Information processing device 1 may or may not be mounted on a real robot. When information processing device 1 is not mounted on a real robot, the generated program code can be transmitted to the real robot wirelessly or by wire.

### Modification 2

In the above description, transfer unit 23 acquires the successful experience having the highest similarity from storage 12 as an example, but the present disclosure is not limited to this configuration. Transfer unit 23 may acquire a plurality of successful experiences (for example, the top three) from storage 12 in descending order of similarity. Transfer unit 23 may generate a plurality of (for example, three) example answers suitable for the target environment based on the plurality of successful experiences acquired from storage 12 and the example answers in the target environment input by the user to the prompt. Then, code output unit 22 may generate a program code by learning the plurality of example answers generated by transfer unit 23. By learning the plurality of example answers based on the successful experiences in this manner, a program code with improved possibility (probability) of appropriately solving the query for the virtual robot can be generated.

### Modification 3

Storage 12 may store a failure experience. That is, storage 12 may store the program code, the environment, the type, and the query of a case where it is evaluated that the virtual robot has not appropriately solved the query. In this case, transfer unit 23 may instruct the prompt that the failure experience acquired from storage 12 is the program code of failure experience. In this case, an appropriate example answer not including failure experience can be generated.

### Modification 4

As described in “Program code generation operation in target environment”, when it is not evaluated that the query has been appropriately solved with the re-planned program code, re-planning unit 24 re-plans a program code. When re-planning unit 24 re-plans a program code, transfer unit 23 may acquire a successful experience different from the past from storage 12. For example, transfer unit 23 may acquire, from storage 12, a successful experience having the second highest similarity after the successful experience acquired last time. This makes it possible to prevent repetition of the same evaluation.

### Modification 5

In the above description, in execution of re-planning, information processing device 1 converts the style of the successful experience into the example answer input by the user and generates a program code using the style-converted example answer. However, the present disclosure is not limited to this configuration. Information processing device 1 may convert the style of the successful experience into the example answer input by the user from the beginning (before generating the first program code) and generate the first program code using the style-converted example answer.

For example, information processing device 1 acquires, from storage 12, successful experiences similar to “Example1” and “Example2” (example answers) illustrated in prompt A8a in FIG. 8. Information processing device 1 generates an example answer using the successful experience based on the successful experience acquired from storage 12 and “Example1” and “Example2” input by the user. Information processing device 1 learns the example answer using the successful experience and generates a program code in the target environment.

This can generate a program code that appropriately solves the query from the beginning (from the first time). In addition, because the program code that appropriately solves the query can be generated from the beginning, execution of re-planning can be suppressed.

· Modification 6

In the above description, the robot operation environment is different between the target environment and the source environment, but the present disclosure is not limited to this configuration. The robot operation environments of the target environment and the source environment may be the same. Even though the target environment and the source environment are the same robot operation environments (not a new robot operation environment for the user), a user having little experience in the robot operation environment can generate an appropriate program code by using information processing device 1.

When the target environment and the source environment are the same, there is a high possibility that the successful experience in the source environment can be directly used in the target environment. More specifically, when the source environment and the target environment are the same, there is a high possibility that the necessary initialization processing, the range in which the robot can operate, and the like are the same, and thus, there is a high possibility that it is not necessary to add or modify information included in the successful experience of the source environment for the target environment. Thus, when the target environment and the source environment are the same, the processing by transfer unit 23 may be omitted. When the target environment and the source environment are the same, the successful experience in the source environment can be used as it is as an example answer in the target environment, and thus, the input of the example answer by the user may be omitted. When the input of the example answer is omitted, the query (in the example of FIG. 4, "Query: throw away the trash, leaving any other objects alone.") to be solved this time may be used as the query example to acquire successful experience.

### Modification 7

In the above description, in the planner level, the successful experience corresponding to the similar query in the source environment is obtained, and the style conversion for the target environment is performed and reflected in the prompt. The same processing may be performed in other levels such as composer and LMP. However, in general, the higher the level, the higher the degree of freedom of code selection, and thus, in many cases, the result does not change before and after style conversion in the lower level such as LMP. Thus, the idea of the present exemplary embodiment is more effective when applied to the planner or the composer.

### Modification 8

In the above description, an example of generating a code having a three-layer structure of planner, composer, and LPM based on the structure adopted by VoxPoser has been described. When another code generator is used, a code having another hierarchical structure may be generated. The hierarchical structure of code may be different between the source environment and the target environment. For example, the successful experience of the source environment may be a code with a three-layer structure, and the code desired to be executed in the target environment may be a code with a one-layer structure. In the above-described exemplary embodiment, the successful experience of the source environment is used as a reference when generating a code in the target environment. Thus, there is a low possibility that the code output for the target environment becomes a code having an incorrect hierarchical structure even with reference to the successful experience having a hierarchical structure different from that of the target environment.

### Modification 9

In the above description, among the successful experiences of the source environment, the successful experience corresponding to the query having high similarity with the query to be input to the prompt is obtained and reflected in the prompt of the target environment. However, a successful experience having high similarity may be acquired and reflected on a basis different from the query. For example, a successful experience having high similarity of the environment in which the robot operates may be acquired and reflected.

As the similarity of the environment, for example, similarity of objects placed around the robot and disposition thereof can be considered. For example, when there is an obstacle near the initial position of the robot, it is necessary to correct the initial position regardless of the operation of the robot. However, when only a successful experience with similar query but in a completely different environment is acquired, there is no description regarding correction of the initial position in the successful experience. Thus, a program code including processing of correcting the initial position is not generated even with reference to the successful experience. Thus, style conversion based on a viewpoint different from the operation of the robot can be performed by acquiring a successful experience in a similar environment regardless of the content of the query.

The similarity of the query does not need to be evaluated based on the similarity of the entire query. For example, when a part of the query is similar, it may be evaluated that the query is similar. As a part of the query, a part of the query particularly related to the operation of the robot is conceivable. For example, when the similarity based on the entire query "grasp the rubbish" is evaluated, there is a possibility that the successful experience of grasping something unrelated to the rubbish is determined to have low similarity. However, there is a high possibility that the successful experience of realizing "grasping" operation includes similar operation regardless of whether the object to be held is a rubbish or a ball. In addition, when there is little accumulation of successful experiences regarding “rubbish”, there is a possibility that the successful experience itself similar to the entire “grasping the rubbish” cannot be acquired. Thus, with a configuration in which a successful experience in which a part of the query is similar is acquired, a wider variety of successful experiences can be acquired. For example, by focusing on "grasp" in the query "grasp the rubbish" and evaluating the similarity, it is possible to acquire a successful experience of performing "grasping" operation on another object, and thus, more successful experiences regarding "grasping" operation can be reflected in the prompt.

The similarity may be evaluated on a plurality of criteria, such as the similarity of the environment, the similarity of the entire query, and the similarity of a part of the query, to obtain a successful experience, and the successful experience obtained on each criterion may be reflected in the prompt. With this configuration, various successful examples of the operation similar to the operation to be performed this time can be collected and reflected in the prompt.

### Modification 10

In the above description, the program code with which it is confirmed that the query has been solved by the virtual robot operation environment, the user, or the like is treated as the program code used for solving the query and used as a successful experience. However, the program code used for solving the query does not have to be the program code with which it is confirmed that the query has been solved. For example, a program code such as a simple program code with which it is clear that the query is solved may be treated as the program code used for solving the query and used as a successful experience.

### Modification 11

In the above description, both the query and the program code that has solved the query have been acquired as the successful experience. However, the object to be obtained or used as the successful experience may be only a part of the program code. In the above description, the program code acquired as the successful experience is a program code that solves a query similar to the query to be solved this time. Thus, even though only the program code excluding the query portion is learned by LLM, the successful experience in the similar query can be reflected in the generation of the program code. However, because LLM generates an output in comprehensive consideration of the provided information, using both the obtained query and the program code as the successful experience may be more accurate. For example, from only the acquired program code, it is not known whether the program code has solved a query having very high similarity with the query to be solved this time or has solved a query that has been determined to be similar but not having high similarity. Thus, when it is desired to more intensively reflect the successful experience having higher similarity in the generation of the program code, the accuracy may be improved by treating both the query and the program code as the successful experience.

### Modification 12

In the above description, robot operation has been described as an example. However, the idea of the above-described exemplary embodiment can be applied to a case other than robot operation. For example, the idea of the above-described exemplary embodiment can also be used for generating a manual for human workers at a certain work site with reference to a manual for human workers at another work site or for generating a computer program for an OS with reference to a computer program for another OS. That is, the idea of the above-described exemplary embodiment can be widely applied to a case where a code or document is generated by LLM based on a code or document that can be used as a successful experience.

Although the exemplary embodiment has been described with reference to the accompanying drawings, the present disclosure is not limited to the examples. Those skilled in the art can clearly and easily conceive of various changes or modifications within the scope of claims. Such changes or modifications are also understood to belong to the technical scope of the present disclosure. In addition, within a range without departing from the gist of the present disclosure, the components in the exemplary embodiment may be combined as appropriate.

The expression, “... part”, used for each component in the above-described exemplary embodiment may be replaced with another expression such as “... circuit (circuitry)”, “... assembly”, “... device”, “... unit”, or “... module”.

The present disclosure can be realized by software, hardware, or software in cooperation with hardware. Each functional block used in the description of the above exemplary embodiment may be partially or entirely achieved as a large-scale integration (LSI) which is integrated circuitry, and each processing described in the above exemplary embodiment may be partially or entirely controlled by one LSI or a combination of LSIs. The LSI may be configured by individual chips, or may be configured by one chip to include some or all of the functional blocks. The LSI may include an input and an output of data. The LSI may be referred to as integrated circuitry (IC), system LSI, super LSI, or ultra LSI depending on the degree of integration.

The technique of realizing integrated circuitry is not limited to the LSI but may be realized by using dedicated circuitry, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

Further, when a circuitry integration technology replacing the LSI appears due to the progress of the semiconductor technology or another derived technology, the functional blocks may be integrated naturally by using the technology. There is a possibility of application of biotechnology.

The present disclosure is useful for solving a query in a situation such as automatically operating a robot or automatically moving a system.

What is claimed is:

1. An information processing device comprising:
an input unit that receives an input of a prompt including a query for causing a robot to execute a task and a query example;
an acquisition unit that acquires, from a storage that stores a program code used to solve a query for the robot, a program code used to solve a query similar to the query example included in the prompt; and
an output unit that causes a large language model that has learned the program code that has been acquired to generate and output a program code that solves the query included in the prompt.

2. The information processing device according to claim 1, wherein
the prompt further includes a program code example that solves the query example,
the information processing device further includes an editing unit that edits the program code that has been acquired based on the program code example, and
the output unit causes the large language model that has learned the program code that has been edited to generate and output the program code that solves the query included in the prompt.

3. The information processing device according to claim 2, wherein
the storage stores a query and a program code in a first environment of the robot in association with each other, and
the query example and the program code example included in the prompt are a query example and a program code example in a second environment of the robot.

4. The information processing device according to claim 1, wherein
when the generated program code has not appropriately solved the query included in the prompt,
the acquisition unit acquires a program code used for solving another query similar to the query example, and
the output unit causes the large language model that has learned the program code that has solved the other query to generate and output a program code for solving the query included in the prompt.

5. The information processing device according to claim 1,
the information processing device storing the query included in the prompt and the program code that has been output in association with each other in the storage when the program code that has been generated appropriately solves the query included in the prompt.

6. The information processing device according to claim 1, wherein
the storage further stores a program code used for solving a query for the robot in one or more environments,
the acquisition unit acquires a program code used in an environment similar to an environment in which the robot is caused to execute a task, and
the output unit causes the large language model that has learned the program code that has been acquired to generate and output a program code that solves the query included in the prompt.

7. A program output method comprising:
accepting an input of a prompt including a query for causing a robot to execute a task and a query example;
acquiring, from a storage that stores a program code used to solve a query for the robot, a program code used to solve a query similar to the query example included in the prompt; and
causing a large language model that has learned the program code that has been acquired to generate and output a program code that solves the query included in the prompt.

8. A program recording medium containing a program for causing a processor to execute processing of:
accepting an input of a prompt including a query for causing a robot to execute a task and a query example;
acquiring, from a storage that stores a program code used to solve a query for the robot, a program code used to solve a query similar to the query example included in the prompt; and
causing a large language model that has learned the program code that has been acquired to generate and output a program code that solves the query included in the prompt.
